(19) United States
(12) Patent Application Publication
(10) Pub. No.: US 2009/0109449 A1
(43) Pub. Date: Apr. 30, 2009

(54) Image Processing Apparatus for Printing Image, Image Processing Method, and Computer Program

(75) Inventor: Yoshida Seishin, Azumino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/256,372

(22) Filed: Oct. 22, 2008

(30) Foreign Application Priority Data
Oct. 31, 2007 (JP) 2007-282962

(51) Int. Cl. G06K 15/10

(52) U.S. Cl. 358/1.8

(57) ABSTRACT

An image processing apparatus for printing an image by recording a plural kinds of ink dots having different sizes on a print medium includes a print image placement acquiring unit which acquires placement of print images on the print medium, in which the print images are to be printed on the print medium, and a print data generating unit which generates print data representing a recording state of the plural kinds of dots on the basis of ink amount data representing ink amount which is recorded on the print medium, in which the print data generating unit generates the print data so that the number of recordings for a specific kind of dots of the plural kinds of ink dots has different values according to placement of the print image with respect to the same ink amount data.

### BACKGROUND

1. Technical Field

The present invention relates to an image processing technique for printing an image.

2. Related Art

According to JP-A-2004-160913, JP-A-2003-118088, JP-A-2003-266700, and JP-A-2005-001202, multi-size dot printing, in which a plurality of ink dots having different sizes is recorded (formed) on a print medium, is performed to precisely reproduce the gray scale of an image (print image) printed on the print medium, such as print paper. In the case of performing the multi-size dot printing, when a recording position (landing position), at which an ink dot having a size which is almost the same as a pixel size (hereinafter, referred to as “print resolution”) determined by print resolution is formed, is deviated from a preset position, banding occurs on the print image and the quality of the print image deteriorates.

In the case of printing an image, however, in a certain transporting state of the print medium or a certain driving state of an ink head which discharges ink dots, precision of landing positions of the ink dots is likely to be lowered and the quality of the print image is likely to deteriorate according to the positions at which the ink dots are recorded. This problem is common for various kinds of printers which perform the multi-size dot printing rather than gives rise only to only an ink-jet printer.

### SUMMARY

It is an object of the invention to provide a technique of suppressing deterioration of image quality of a print image in a printer which performs multi-size dot printing.

The invention is made in order to solve at least part of the above-mentioned problem and can be realized by the following aspects or application examples.

According to a first aspect of the invention, there is provided an image processing apparatus for printing an image by recording a plural kinds of ink dots having different sizes on a print medium, including a print image placement acquiring unit which acquires placement of a print image on the print medium, which is printed on the print medium, and a print data generating unit which generates print data representing the plural kinds of dots using ink amount data representing ink amount recorded on the print medium, in which the print data generating unit generates the print data so that the number of recordings for a specific kind of dots of the plural kinds of ink dots has different values according to placement of the print image with respect to the same ink amount data.

In the image processing apparatus according to the first aspect, the print data in which the number of recordings for the specific kind of dots is different according to the placement of the print image with respect to the same ink amount data is generated. Accordingly, it is possible to suitably adjust a recording rate of the specific kind of dots according to precision of recording positions of ink dots.

In the image processing apparatus, it is preferable that the specific kind of ink dots be ink dots having a size which is more approximate to a pixel size determined by print resolution rather than a size of ink dots other than the specific kind of ink dots of the plural kinds of ink dots, and the print data generating unit generates the print data so that the number of recordings for the specific kind of ink dots in the case in which the print image is not placed at a center portion of the print medium is smaller than the number in the case in which the print image is placed on the center portion of the print medium.

Precision of recording positions of ink dots at peripheral portions of the print medium is lower than that at the center portion of the print medium. Accordingly, in the case in which the print image is not placed at the center portion of the print medium, it is possible to more effectively suppress deterioration of the image quality of the print image which is attributable to lowering of the precision of recording positions by decreasing the number of recordings of ink dots having a size approximate to the print resolution.

In the image processing apparatus, it is preferable that the print data generating unit include a recording rate data generating unit which generates recording rate data on the basis of the ink amount data and a data converting unit which converts the recording rate data to the print data, in which the recording rate generating unit sets a maximum recording rate for the specific kind of ink dots differently according to the placement of the print images.

In the image processing apparatus, the maximum recording rate for the specific kind of ink dots is set to be different according to the placement of print images. Accordingly, it becomes easier change the number of recordings for the specific kind of ink dots according to the placement of print images.

In the image processing apparatus, it is preferable that the recording rate generating unit include a first recording rate table showing a relationship between the ink amount and a recording rate of each of the plural kinds of ink dots, a second recording rate table, of which a maximum recording rate of the specific kind of ink dots is different from that of the first recording rate table, and a recording table selecting unit which selects either the first recording rate table or the second recording rate table as a recording rate table to be used to generate the recording rate data.

With this structure, the recording rate table selecting unit can set a value of the maximum recording rate for the specific kind of ink dots differently according to the placement of the print images by selecting either the first recording rate table or the second recording rate table, in which the maximum recording rates for the specific kind of ink dots in the first recording rate table and the second recording rate table are different from each other.

The invention can be realized in various forms. For example, The invention can be realized in the forms of an image processing apparatus, an image processing method, an image printing apparatus, an image printing method, and an image printing system which use the image processing apparatus and the image processing method, a computer program for realizing functions of such apparatuses, methods and systems, a recording medium storing the computer program therein, and a data signal which includes the computer program and is embodied in carrier waves.

### BRIEF DESCRIPTION OF THE DRAWINGS

The invention will be described with reference to the accompanying drawings, wherein like numbers reference like elements.

FIG. 1 is an explanatory view illustrating an overall structure of an image printing system according to a first embodiment of the invention.

FIG. 2 is a block diagram illustrating a functional structure of a printer driver 300.

FIGS. 3A and 3B are explanatory views illustrating a relationship between ink amount and a recording rate of each dot of small-sized, middle-sized, and large-sized dots in each of recording rate tables 336 and 338.

FIG. 4 is a flowchart illustrating the sequence of print data generation processing in the printer driver 300.

FIGS. 5A and 5B are explanatory views illustrating the influence imparted to a print image by a skew.

FIGS. 6A and 6B are explanatory views illustrating a state in which small-sized, middle-sized, and large-sized dots are formed on print paper.

FIGS. 7A and 7B are explanatory views illustrating a modification of a recording rate table.

FIG. 8 is a flowchart illustrating the sequence of print data generation processing according to a second embodiment.

FIG. 9 is a block diagram illustrating a functional structure of a printer driver 300b according to a third embodiment of the invention.

FIG. 10 is a flowchart illustrating the sequence of print data generation processing according to the third embodiment.

FIGS. 11A and 11B are explanatory views illustrating exemplary placements of print images on the print paper PTS.

### DESCRIPTION OF EXEMPLARY EMBODIMENTS

Hereinafter, embodiments of the invention will be described in the follower order.

A. first embodiment

B. a modification of a recording rate table

C. second embodiment

D. third embodiment

E. modifications

### A. First Embodiment

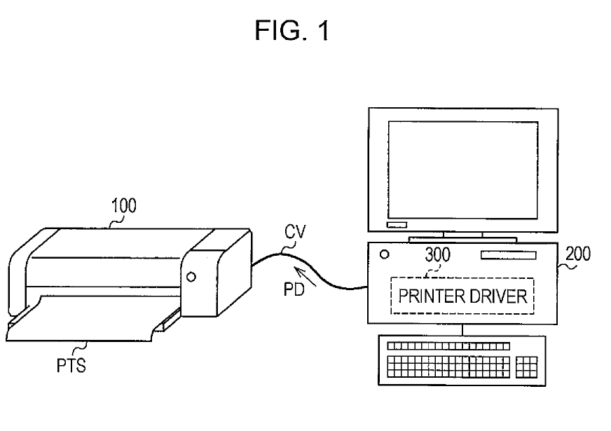

FIG. 1 is an explanatory view illustrating an overall structure of an image printing system according to a first embodiment. The image printing system includes a printer 100 and a computer 200. The printer 100 is an ink-jet printer which forms an image on print paper PTS by discharging ink droplets to the print paper PTS. The printer 100 and the computer 200 are connected to one another by a cable CV. The printer 100 discharges ink droplets to the print paper PTS on the basis of print data PD transmitted from the computer 200 via the cable CV.

A printer driver 300 is installed in the computer 200. The printer driver 300 is a module for generating print data PD using image data. The print data PD generated by the printer driver 300 includes raster data which represents a recording state of ink dots (hereinafter simply referred to as “dots”) as having three sizes (small, middle, and large) with respect to each pixel having the print resolution in a main scan line. The dots are not necessarily limited to only three kinds. Generally, the dots may be two or more kinds.

The program for realizing functions of the printer driver 300 can be transferred to the computer 200 in the form recorded in a computer-readable recording medium or in the form contained in a data signal which is embodied in carrier waves.

With the first embodiment, the printer 100 serving as an image outputting apparatus and the computer 200 serving as an image processing apparatus are separately provided, but the function of the image processing apparatus may be incorporated into the printer.

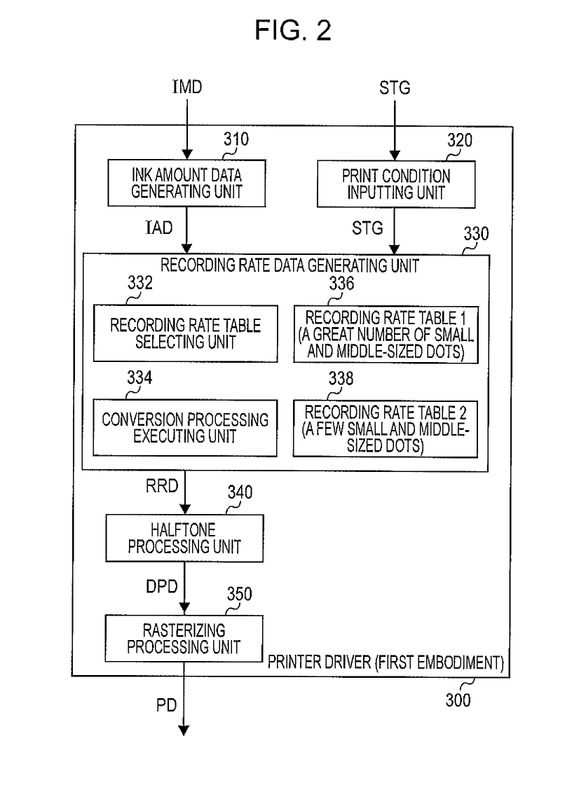

FIG. 2 is a block diagram illustrating a functional structure of the printer driver 300. The printer driver 300 includes an ink amount data generating unit 310, a print condition inputting unit 320, a recording rate data generating unit 330, a halftone processing unit 340 and a rasterizing processing unit 350.

The ink amount data generating unit 310 generates ink amount data IAD by performing color conversion with respect to the image data IMD transmitted to the printer driver 300. The generation of the ink amount data IAD is performed by converting RGB color component values of the image data IMD to CMYK color component values corresponding to the ink amount with reference to a color conversion look-up table (LUT) which is not shown. The ink amount data IAD generated by the ink amount data generating unit 310 is transmitted to the recording rate data generating unit 330.

The print condition inputting unit 320 receives various setting inputs relating to print condition STG which are set in the printer driver 300. The set print conditions STG are transmitted to the recording rate data generating unit 330. With the first embodiment, of the print conditions STG inputted by the print condition inputting unit 320, a size of print paper (paper size) is transmitted to the recording rate data generating unit 330.

The recording rate data generating unit 330 includes a recording rate table selecting unit 332, a conversion processing executing unit 334, and two recording rate tables 336 and 338. The recording rate table selecting unit 332 selects a recording rate table from the recording rate table 336 and the recording rate table 338 on the basis of the print conditions STG inputted by the print condition inputting unit 320. The conversion processing executing unit 334 converts the ink amount data IAD transmitted from the ink amount data generating unit 310 to the recording rate data RRD which represents small-sized, middle-sized, and large-sized dots with reference to the selected recording table. The recording rate means a rate for recording pixel dots in a certain area. The contents of two recording rate tables 336 and 338 and selection of the recording table by the recording rate table selecting unit 332 will be described later. The generated recording rate data RRD is transmitted to the halftone processing unit 340.

The halftone processing unit 340 generates dot placement data DPD which represents placement of dots using the recording rate data RRD by performing halftone processing. The generated dot placement data DPD is arranged in a main scan direction by the rasterizing processing unit 350, and raster data which represents a generation state of dots in the main scan direction is generated. The print data PD containing the raster data is generated using the generated raster data.

As described above, generation of the print data PD from the ink amount data IAD is performed by functions of the recording rate data generating unit 330, the halftone processing unit 340, and the rasterizing processing unit 350. Accordingly, the function of the print data generating unit which generates the print data PD from the ink amount data IAD is realized by three units of the recording rate generating unit 330, the halftone processing unit 340, and the rasterizing processing unit 350. The conversion from the recording rate data RRD to the print data PD is performed by the halftone processing unit 340 and the rasterizing processing unit 350. For such a reason, the function of the data converting unit which converts the recording rate data RRD to the print data PD is realized by two units of the halftone processing unit 340 and the rasterizing processing unit 350.

The generated print data PD is transmitted to the printer 100 from the printer driver 300 via an interface device (not shown) provided to the computer 200 (see FIG. 1) and the cable CV. Ink is discharged to the print paper PTS according to the print data PD transmitted from the printer 100 and therefore an image represented by the image data IMD is formed on the print paper PTS.

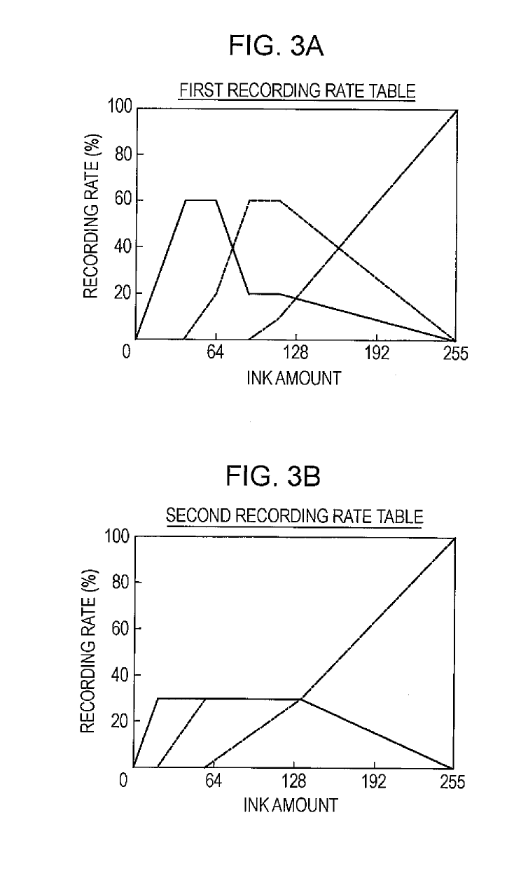

FIGS. 3A and 3B are explanatory views illustrating a relationship between ink amount and a recording rate of each of small-sized, middle-sized, and large-sized dots in each of two recording rate tables 336 and 338. FIG. 3A shows the relationship between the ink amount and the recording rates in the first recording rate table 336. FIG. 3B shows the relationship between the ink amount and the recording rates in the second recording rate table 338. In FIGS. 3A and 3B, a solid line represents a recording rate of small-sized dots according to the ink amount. A dotted line represents a recording rate of middle-sized dots according to the ink amount. A dashed-dotted line represents a recording rate of large-sized dots according to the ink amount.

As shown in FIG. 3A, in the first recording rate table 336, a maximum value of the recording rates for the small-sized and middle-sized dots (maximum recording rates) is set to 60%. On the other hand, as shown in FIG. 3B, in the second recording rate table 338, a maximum recording rate for the small-sized and middle-sized dots is set to 30% which is lower than that in the first recording rate table 336. For such a reason, the number of small-sized and middle-sized dots formed on the print paper PTS in the case of using the second recording rate table 338 is smaller than the number in the case of using the first recording rate table 336.

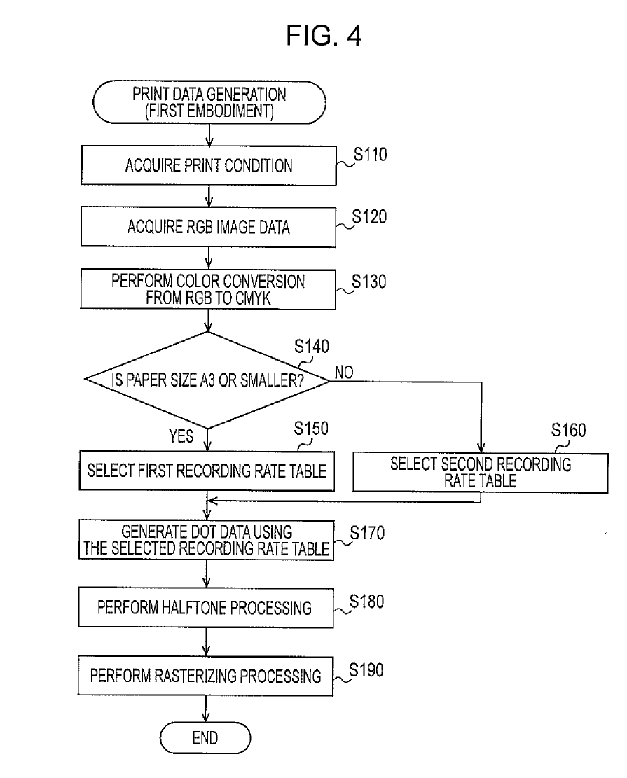

FIG. 4 is a flowchart illustrating the sequence of print data generation processing performed by the printer driver 300. The print data generation processing is performed in a manner such that a CPU (not shown) incorporated in the computer 200 executes a program which realizes a function of the printer driver 300.

In Step S110, the recording rate data generating unit 330 acquires print conditions STG set by the print condition inputting unit 320. As described above, the recording rate data generating unit 330 in the first embodiment acquires a paper size of various print conditions STG.

In Step S120, the ink amount data generating unit 310 acquires the image data (RBG image data) IMD having RGB color component values. Next, in Step S130, the ink amount data generating unit 310 converts the RGB color component values to CMYK color component values with respect to the RGB image data IMD acquired in Step S120.

In Step S140, the recording rate table selecting unit 332 of the recording rate data generating unit 330 determines whether the paper size is A3 or not. In the case in which the paper size is A3 or smaller Step S150 is performed. In Step S50, the first recording rate table 336 having a relatively high maximum recording rate for the small-sized and middle-sized dots is selected by the recording rate table selecting unit 332. On the other hand, in the case in which the paper size is larger than A3, Step S160 is performed. In Step S160, the second recording rate table 338 having a relatively low maximum recording rate for the small-sized and middle-sized dots is selected by the recording rate table selecting unit 332.

In Step S170, the conversion processing executing unit 334 generates the recording rate data RRD which represents the ink amount for the small-sized, middle-sized, and large-sized dots as recording rates, respectively, using a recording rate table selected from two recording rate tables 336 and 338. In greater detail, it specifies the recording rates of the small-sized, middle-sized, large-sized dots, respectively which correspond to the ink amounts. Then, the recording rate data RRD which represents the specified recording rate is generated.

In Step S180, the halftone processing unit 340 generates the dot placement data DPD using the recording rate data RRD. In Step S190, the rasterizing processing unit 350 generates the print data PD using the dot placement data DPD which is generated in Step S180. The generated print data PD is transmitted to the printer 100 (see FIG. 1) and then the image is formed on the print paper PTS.

However, when forming the image by the printer 100, if the placement of the print paper PTS on which the image is formed is inclined with respect to a sub-scan direction (transporting direction of print paper PTS), it is likely to impart negative influence to the image formed on the print paper PTS (hereinafter, referred to as print image).

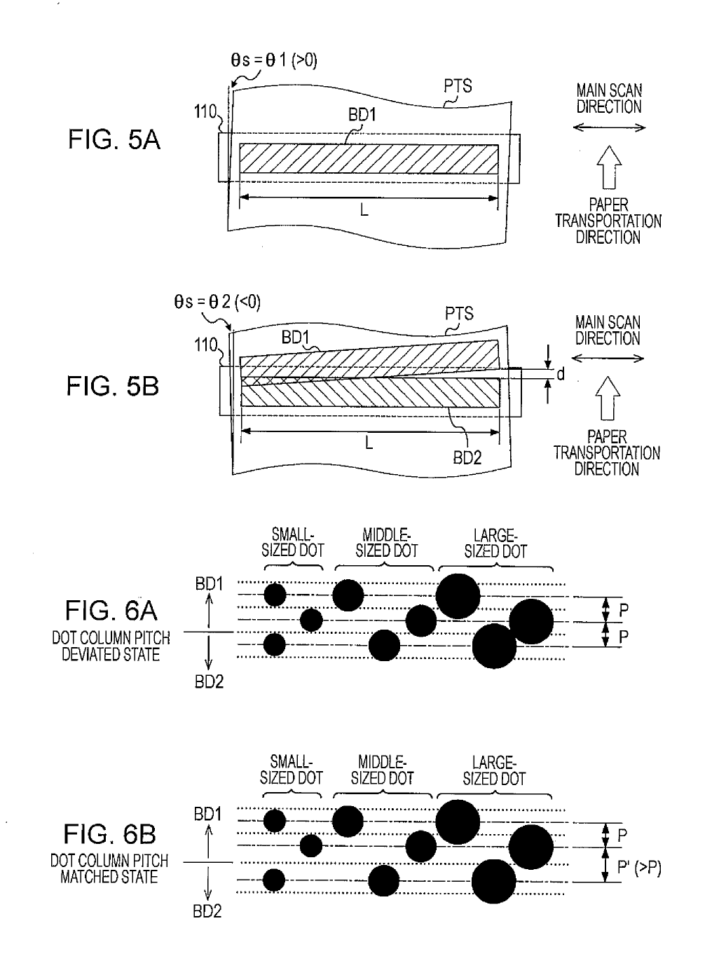

FIGS. 5A and 5B are explanatory views illustrating how the deviation (skew) of the print paper PTS affects the print image. FIG. 5A and FIG. 5B show a situation in which the image (band) is being sequentially formed on the print paper PTS by main scanning as the print paper PTS is gradually transported in a paper transporting direction (direction in which the print paper PTS is transported) by driving a platen 110.

In an example of FIG. 5A, the print paper PTS is being fed inclining with respect to the paper transporting direction. For such a reason, as shown in FIG. 5A, edges at both ends of the print paper PTS in the main scan direction, and the paper transporting direction are not parallel with one another. Hereinafter, an angle between the left and right edges of the print paper PTS and the paper transporting direction is called “skew angle θs”

The main scan direction in which the band is formed is a direction of an axis of the platen 110, i.e. a direction perpendicular to the paper transporting direction. Accordingly, in an example of FIG. 5A in which the skew angle θs is θ1 (>0), the band BD1 which is hatched is formed inclining to the edge of the paper print PTS.

After the band BD1 is formed on the print paper PTS, the print paper PTS is transported in the paper transporting direction. A transporting mechanism of the print paper PTS generally includes a paper transporting guide (not shown) which controls an orientation of the print paper PTS so as to accord with the paper transporting direction. Accordingly, if the print paper PTS inclining to the paper transporting direction is transported as shown in FIG. 5A, the orientation of the print paper PTS changes as soon as the print paper PTS reaches the guide.

FIG. 5B shows a state in which the orientation of the print paper PTS is different from that of FIG. 5A. In an example of FIG. 5B, the print paper PTS is inclined in the opposite direction to the example of FIG. 5A. Accordingly, the skew angle θs is changed from θ1 to θ2 (<0).

IF the print paper PTS on which the band BD1 is formed is transported and a band DB2 is formed on the transported print paper PTS, two bands BD1 and BD2 formed on the print paper PTS overlap each other at one side but are spaced apart from one another at the other side.

A width d by which two bands BD1 and BD2 overlap or are spaced apart at both end portions of the bands in the main scan direction is expressed by an expression (1) using a band width L and a skew difference Δθs (=θ2−θ1) between the skew angles θs when two bands BD1 and BD2 are formed.

d=L/2×sin(Δθs)≅L/2×Δθs (1)

The angle difference Δθs is sufficiently smaller than 1. Accordingly, in the expression (1), the width d can be a value of multiplication of ½L(band width) and Δθs.

As shown in the expression (1), the width d by which two bands BD1 and BD2 are spaced apart from one another is increased as the width L of each of the bands BD1 and BD2 is increased. Accordingly, the larger the size of the print paper PTS is, the lower the precision of positions of the bands BD1 and BD2 is. FIGS. 5A and 5B show examples in which the precision of positions of the bands BD1 and BD2 is lowered due to the skew, i.e. the state in which the print paper PTS is transported as inclined. However, as the size of the print paper PTS increases, a pitch between bands (dot columns) in the main scan line is more likely to deviate from print resolution.

FIGS. 6A and 6B are explanatory views illustrating a state in which small-sized, middle-sized, and large-sized dots are formed on the print paper. FIG. 6A shows a state in which a pitch of the dot columns maintains the print resolution and FIG. 6B shows a state in which the precision of formed positions of two bands BD1 and BD2 is lowered and a pitch of the dot columns is increased at some positions and is larger than the print resolution P, as shown in FIGS. 5A and 5B. In FIGS. 6A and 6B, black dots represent small-sized, middle-sized, and large-sized dots. A dashed-dotted line represents the main scan direction in which these dots are arranged, and also a direction of the dot columns. A dotted line represents a center line between the dot columns.

In an example of FIG. 6A, a pitch of dot columns maintains the print resolution P. Accordingly, the small-sized, middle-sized, and large-sized dots are arranged in the sub-scan direction with the print resolution P. In this manner, since the small-sized, middle-sized, and large-sized dots are formed to be spaced apart from one another by a uniform distance in the sub-scan direction, the image formed by these dots is a good quality image without banding.

On the other hand, in an example of FIG. 6B, a pitch of the uppermost two dot columns is the print resolution P but a pitch of the lowermost two dot columns is a large pitch P1 which is beyond the print resolution. In this manner, if the pitch of the dot columns becomes larger than the print solution P, in an image formed by the small-sized and middle-sized dots, a diameter (size) of the dots is approximate to the print resolution P, space attributable to the large pitch easily stands out and banding is likely to easily occur. On the other hand, in an image formed by the large-sized dots, since a diameter of the dots is larger than the print resolution P, the space attributable to the large pitch of the dot columns is hardly visible and occurrence of the banding is suppressed.

In the first embodiment, in the case in which the paper size is larger than A3, i.e. in the case in which the pitch of column dots is likely to be deviated from the print resolution P, the recording rate data RRD is generated using the second recording rate table 338 in which a recording rate of small-sized and middle-sized dots is relatively low. Accordingly, the print data PD is generated using the generated recording rate data RRD. In the case in which the image is formed using the generated print data PD, it is possible to suppress occurrence of banding attributable to the deviation of the pitch of dot columns.

On the other hand, in the case in which the paper size is A3 or smaller, the deviation of the pitch of dot columns is not so large. Further, in the case in which the paper size is small, the printed image can be visible in a smaller distance than in the case in which the image is printed on large print paper. In this case, it is possible to suppress lowering of graininess of the printed image by increasing a ratio of small-sized and middle-sized dots formed using the first recording rate table 336.

In the first embodiment, the recording table is selected according to the determination result of whether the paper size is larger than A3. However, the paper size which is used as the reference for determining the recording rate table may be differently set according to the characteristic of the printer 100 (see FIG. 1). In the case in which the printer 100 is a printer in which the skew is not likely to occur, the recording rate table may be selected according to the determination result of whether the paper sized is A2 or not. On the other hand, in the case in which the printer 100 is a printer by which the skew is likely to occur easily, the recording rate table may be selected according to the determination result of whether the paper size is larger than A4.

In the first embodiment, the recording rate table is selected according to the paper size, but the recording rate table also can be selected according to a parameter representing the size of the print paper PTS. Such a parameter may be a width or a length of the print paper PTS.

### B. Modification of Recording Rate Table

In the first embodiment, in the case in which the paper size is larger than A3, as shown in FIG. 3B, the second recording rate table 338, in which both of the maximum recording rates of small-sized and middle-sized dots are low, is selected. However, in a certain relationship between the diameters of small-sized, middle-sized, and large-sized dots and the print resolutions P, it is possible to suppress occurrence of banding by using a recording rate table different from the second recording rate table 338.

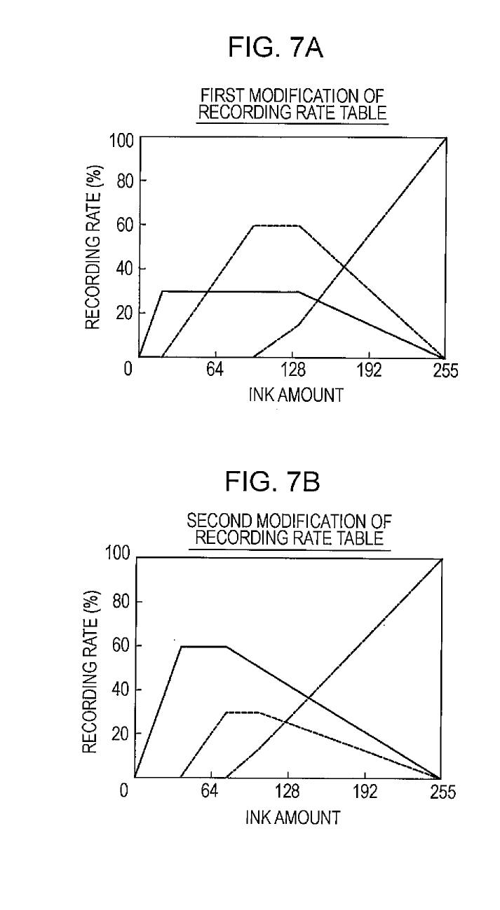

FIGS. 7A and 7B are explanatory views illustrating modifications of the recording rate table. FIG. 7A and FIG. 7B show the relationship between the ink amounts and the recording rates of small-sized, middle-sized, and large-sized dots in each of the modifications. These recording rate tables are different from the second recording rate table 338 of FIG. 3B from the point of view in which only either one of the maximum recording rate of the small-sized dots and the maximum recording rate of the middle-sized dots is low.

In the recording rate table of FIG. 7A, the maximum recording rate of the small-sized dots is set to 30% and the maximum recording rate of the middle-sized dots is set to 60%. In the same manner as the first embodiment, in the case in which the paper is larger than A3, a recording rate table in which the maximum recording rate of the small-sized dots is low is selected. On the other hand, in the case in which the paper size is A3 or smaller, the first recording rate table 336 in which the maximum recording rate of the small-sized dots is high is selected.

In this manner, with the use of the recording rate table shown in FIG. 7A, the number of small-sized dots formed on the print paper PTS is smaller than that in the case of using the first recording rate table 336. As described above, in the case in which the diameter of the small-sized dots is approximate to the print resolution P and the diameter of the middle-sized dots is larger than the print resolution P, it is possible to suppress occurrence of banding attributable to the deviation between the pitch of dot columns and the print resolution P by reducing the number of small-sized dots which are formed.

In an example of FIG. 7B, the maximum recording rate of the small-sized dots is set to 60% and the maximum recording rate of the middle-sized dots is set to 30%. In the case in which the print paper size is larger than A3, the recording rate table in which the maximum recording rate of the middle-sized dots is low is selected. On the other hand, in the case in which the print paper size is A3 or smaller, the first recording rate table 336 in which the maximum recording rate of the middle-sized dots is high is selected.

With the use of the recording rate table shown in FIG. 73, the number of the middle-sized dots formed on the print paper is smaller than that in the case of using the first recording rate table 336. In this manner, in the case in which the diameter of the small-sized dots is sufficiently smaller than the print resolution P and the diameter of the middle-sized dots is approximate to the print resolution P, it is possible to suppress occurrence of banding attributable to the deviation between the pitch of dot columns and the print resolution P by reducing the number of the middle-sized dots which are formed.

For example, in the case in which the diameter of the large-sized dots is approximate to the print resolution P, it is possible to use a recording rate table in which the number of the large-sized dots is a small value. In this case, it is possible to reduce the number of large-sized dots which are formed by setting at least one of the maximum recording rates of the small-sized dots and middle-sized dots to a high value. Further, the number of large-sized dots which are formed may be reduced by changing the degree of the recording rates of the small-sized and middle-sized dots in an area in which the ink amount is large instead of changing the maximum recording rates of the small-sized and middle-sized dots.

### C. Second Embodiment

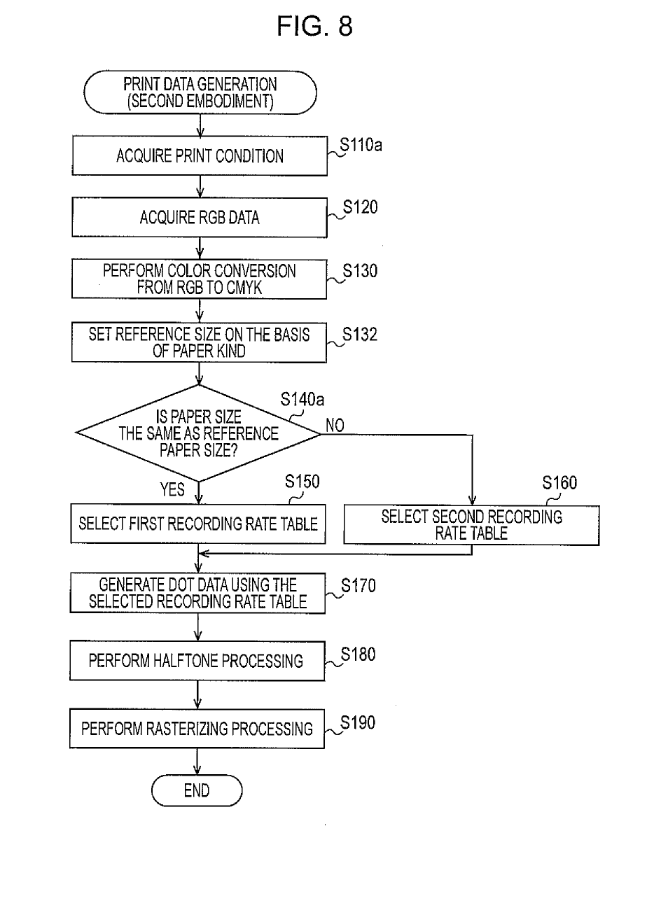

FIG. 8 is a flowchart illustrating the sequence of print data generation processing according to the second embodiment. The print data generation processing of the second embodiment is different from the print data generation processing of the first embodiment shown in FIG. 4 from the point of view in which Step S132a is added after Step S130, and Step S110a and Step S140a are performed instead of Step S110 and Step S140, respectively. Other points are the same as the first embodiment.

In Step S110a, the recording rate data generation unit 330 acquires the paper size and the kind of print paper (print paper kind) of various print conditions STG.

In Step S132, a recording rate table 332 sets a reference size on the basis of the print paper kind acquired in Step S110a. As for the reference size, a relatively small size is set as the reference size when the print paper is paper on which the skew is likely to easily occur, and a relatively large size is set when the print paper is paper on which the skew is not likely to occur. The reference size may be set as in the following table 1.

TABLE 1

| PAPER KIND | REFERENCE SIZE |
|---|---|
| PLAIN PAPER | A4 |
| PHOTOGRAPHIC PAPER | A3 |

In Step S140a, the recording rate table selecting unit 332 determines whether the paper size is the reference size set in Step S132. In the case in which the paper size is the reference size or smaller, Step S150 is performed. On the other hand, in the case in which the paper size is larger than the reference size, Step S160 is performed.

In the second embodiment, the paper size and the reference size set on the basis of the print paper kind are compared. In the case in which the paper size is larger than the reference size, it is possible to suppress occurrence of banding by decreasing a ratio of the small-sized and middle-sized dots. On the other hand, in the case in which the paper size is smaller than the reference size, it is possible to suppress deterioration of graininess of the print image by increasing the ratio of the small-sized and middle-sized dots which are formed.

In the second embodiment, selection of the recording rate table is performed on the basis of the paper kind and the paper size. Accordingly, the second embodiment is superior to the first embodiment from the point of view in which the most suitable recording rate table is selected. On the other hand, the first embodiment is superior to the second embodiment from the point of view in which the processing in the recording rate table selecting unit 332 is simple.

### D. Third Embodiment

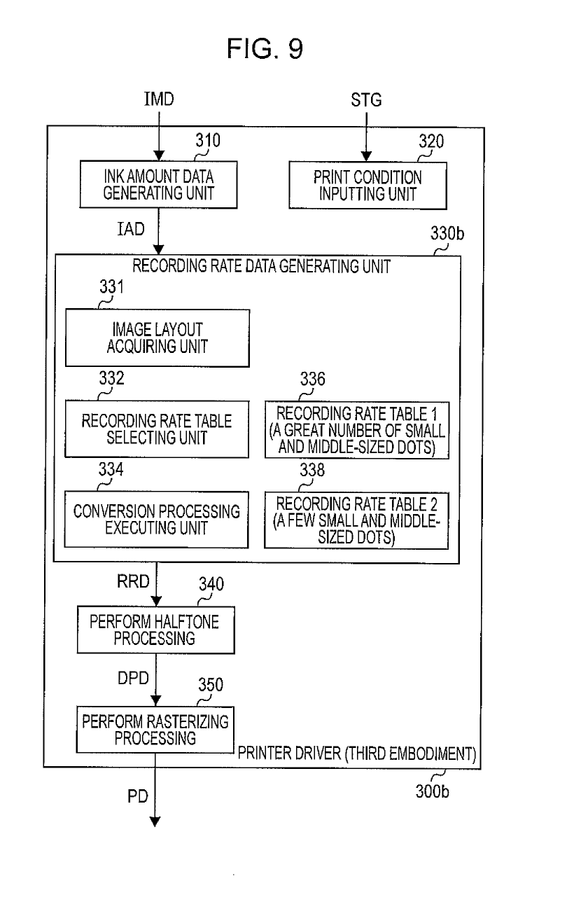

FIG. 9 is a block diagram illustrating a function structure of a printer driver 300b according to the third embodiment. The printer driver 300b of the third embodiment is different from the printer driver 300 of the first embodiment shown in FIG. 2 from the point of view in which the print condition STG is not transmitted to the recording rate data generating unit 330b from the print condition inputting unit 320, and the recording rate data generating unit 330b has an image placement acquiring unit 331. Other points are the same as in the first embodiment.

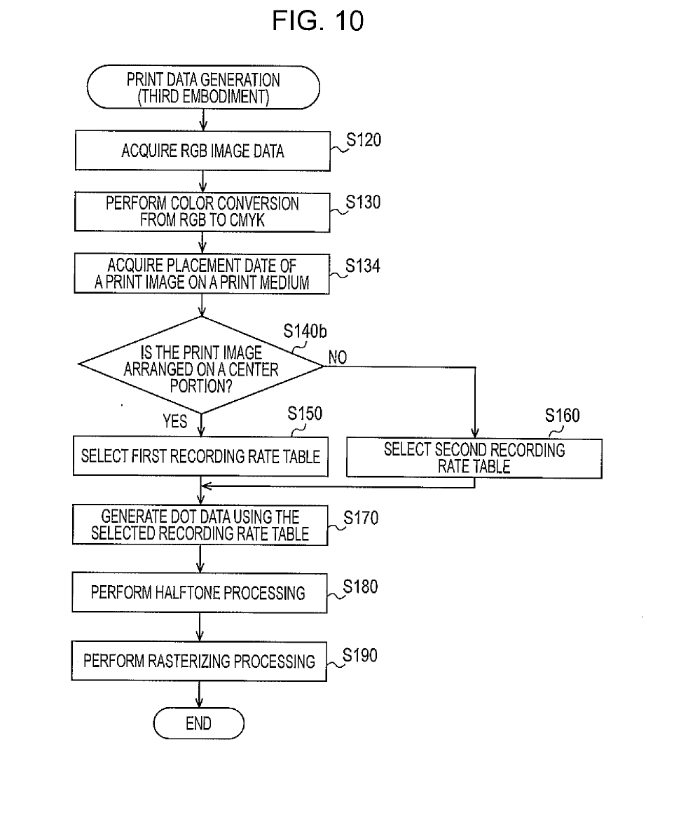

FIG. 10 is a flowchart illustrating the sequence of print data generation processing according to the third embodiment. The print data generation processing according to the third embodiment is different from the print data generation processing of the first embodiment shown in FIG. 4 from the point of view in which Step S110 is omitted, Step S134 performed after Step S130 is added, and Step S140b is performed instead of Step S140. Other points are the same as in the first embodiment.

In Step S134, the image placement acquiring unit 331 acquires print position (placement) of the image on the print paper PTS. The placement of the print image can be acquired by, for example, detecting an area at which the ink amount is not zero (0) (i.e. not white) by analyzing the ink amount data IAD. Alternatively, the placement of the print image may be acquired by analyzing the image data IMD. In the case in which the image data IMD contains placement data which specifies the print position of the image, it may be acquired on the basis of placement data.

In Step S140b, the recording rate table selecting unit 332 determines whether the print image is placed on the center portion in the main scan direction of the print paper PTS. In greater detail, it is determined whether the print image is placed close to the center line of the print paper PTS which is formed along the sub-scan direction. Hereinafter, as long as it is specifically declared, the term “center portion” means a center in the main scan direction, and the term “center line” means a center line of the print paper PTS which extends in the sub-scan line direction. In the case in which the print image is placed at the center portion of the print paper PTS, the control continues with Step S150. On the other hand, in the case in which the print image is not placed at the center portion of the print paper PTS, the control continues with Step S160.

Whether the print image is placed at the center portion of the print paper PTS or not can be determined on the basis of the determination of whether the print image is over the center line. The determination of whether the print image is placed at the center portion also can be determined by other methods. For example, it may be determined on the basis of the determination of whether the print image is in a predetermined area containing the center line or on the basis of the distance between the edge of the print image and the edge of the print paper PTS in the main scan direction.

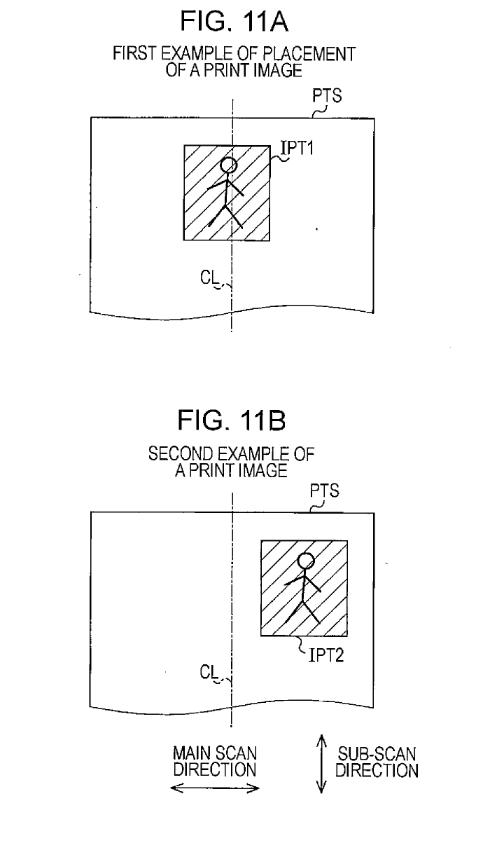

FIGS. 11A and 11B are explanatory views illustrating placement examples of the print image on the print paper PTS. FIG. 11A shows a print image IPT1 placed at the center portion of the print paper PTS and FIG. 11B shows a print image IPT2 placed at a right-side lopsided position of the print paper PTS. In FIGS. 11A and 11B, the center line CL is a center line of the print paper PTS, which extends along the transporting direction of the print paper PTS.

In the third embodiment, it is determined whether the print image is placed at the center portion on the basis of the result whether the print image is over the center line of the print paper PTS. In an example of FIG. 11A, the print image IPT1 is placed on the center line CL. Accordingly, in Step s140 of FIG. 10, it is determined such that the print image IPT1 is placed on the center portion of the print paper PTS. On the other hand, in an example of FIG. 11B, the print image IPT2 is not over the center line CL. In Step S140 of FIG. 10, it is determined such that the print image IPT2 is not placed on the center portion of the print paper PTS.

As shown in FIG. 5, in the case in which the print paper PTS is not matched, the skew angle θs changes as the print paper PTS is transported. However, in even the case in which the skew angle θs changes by the transportation, the deviation of the pitch of the dot columns is smaller at the center portion of the print paper PTS than that at both end portions of the print paper PTS. Accordingly, in the case in which the print image is placed on the center portion of the print paper PTS, the deviation of the pitch of the dot columns is not large. On the other hand, in the case in which the print image is not placed on the center portion of the print paper PTS, the deviation of the pitch of the dot columns is increased.

In the third embodiment, placement of the print image on the print paper PTS can be acquired. In the case in which the print image is not placed at the center portion of the print paper PTS, the recording rate table 338 in which the maximum recording rate for the small-sized and middle-sized dots is relatively low is selected, and a ratio of the small-sized and middle-sized dots which are formed is lowered. Accordingly, in the case in which the print image is not placed at the center portion of the print paper PTS, it is possible to suppress occurrence of banding attributable to deviation of the pitch of dot columns. On the other hand, in the case in which the print image is placed at the center portion of the print paper PTS, it is possible to suppress lowering of graininess of the print image by increasing the ratio of the small-sized and middle-sized dots which are formed.

In the third embodiment, in the case in which the print image is placed at the center portion of the print paper PTS, the recording rate table 338 in which the maximum recording rate of the small-sized and middle-sized dots is relatively low is selected. Accordingly, in the case in which landing positions are displaced in the main scan direction by forming dots while accelerating and decelerating formation of dots, it is possible to suppress lowering of image quality of the print image attributable to deviation of landing positions.

In the third embodiment, the recording rate table used in generation of the recording rate data is selected from two recording rate tables 336 and 338 in which maximum recording rates for the small-sized and middle-sized dots are different from one another on the basis of placement of the print image on the print paper PTS. For such a reason, it is possible to suppress occurrence of banding in the case in which the print image is placed at the center portion of the print paper PTS and also it is possible to improve the image quality of the print image in the case in which the print image is placed at the center portion of the print paper PTS.

With the third embodiment, selection of the recording rate table is performed on the basis of the placement of the print image in the main scan direction. Alternatively, selection of the recording rate table may be performed on the basis of placement of the print image in the transporting direction of the print paper PTS. The skew of the print paper PTS at both end portions of the print paper PTS in the transporting direction is typically larger than that at the center portion in the transporting direction. Accordingly, it is preferable that the first recording rate table 336 be selected in the case in which the print image is placed at the center portion in the transporting direction (sub-scan direction), and the second recording rate table 338 be selected in the case in which the print image is placed at the center portion in the transporting direction.

Selection of the recording rate table may be performed on the basis of both of the placement of the print image in the main scan direction and the placement of the print image in the transporting direction. The selection of the recording rate table can be typically performed on the basis of the placement of the print image on the print paper PTS. In this case, the relationship between the placement of the print image and the selected recording table can change according to the characteristic of the paper feeding of the printer 100.

### E. Modifications

The invention is not limited to the above-mentioned examples and embodiments but various aspects may be implemented within a range which is not departing from the spirit of the invention. For example, the following modifications may be implemented.

### E1. First Modification

In the first and second embodiments, in the case in which the paper size is larger than a predetermined size, the recording rate table 338 in which the maximum recording rate for the small-sized and middle-sized dots is low is used. Generally the recording rate table 338 in which the maximum recording rate for the small-sized and middle-sized dots is low can be used when the paper size is a certain size. For example, in the case in which the paper size is smaller than a predetermined size, the recording rate table 338 in which the maximum recording rate for the small-sized and middle-sized dots is low may be used. In this manner, as the paper size is decreased, in the case in which a contact area between the platen 110 and the print paper PTS is decreased and the paper feeding precision is lowered, it is possible to suppress lowering of the image quality of the print image.

### E2. Second Modification

Of the above embodiments, the third embodiment is applied to a printer driver 300b different from the printer drivers of the first and second embodiments, but the third embodiment may be combined with either the first embodiment or the second embodiment. In greater detail, in the case in which the paper size is larger than a predetermined size, the recording rate table selected according to the placement of the print image on the print paper PTS is used. In the case in which the paper size is smaller than the predetermined size, the recording rate table 336 in which the maximum recording rate for the small-sized and middle-sized dots is high is used.

### E3. Third Modification

The maximum recording rate for the small-sized and middle-sized dots is changed by selecting the recording rate table to be used in generation of the recording rate data RRD (see FIG. 2 and FIG. 9) from the first recording rate table 336 and the second recording rate table 338 in the embodiments, but the maximum recording rate for the small-sized and middle-sized dots may be set by other methods. For example, the recording rate table is generated on the basis of the maximum recording rate which must be set, and the recording rate data RRD is generated from the ink amount data IAD using the generated recording rate table.

### E4. Fourth Modification

In the above embodiments, the maximum recording rate for the dots which are approximate to the print resolution is changed according to the paper size and the placement of the print image. For example, it is preferable that dots smaller than a predetermined size may be used as the dots which are objects of the change of the maximum recording rate. Generally, the dots which are objects of the change of the maximum recording rate are determined on the basis of the image quality of the print image acquired when the paper size and the placement of the print image are changed on an experimental basis on the basis.

### E5. Fifth Embodiment

The above embodiments are explained supposing that the ink amount data IAD (see FIG. 2) has four color component values of CMYK so as to correspond to four kinds of ink, CMYK, used in the printer 100 (see FIG. 1). Generally, the ink amount data IAD is generated as data having the number of color component values, the number corresponding to the number of kinds of ink used in the printer 100.

### E6. Sixth Embodiment

In the embodiments, the invention is applied to the printer driver 300 which generates the print data PD for the ink-jet printer 100 (see FIG. 1), but the invention may be applied to printer drivers which generates print data for any kinds of printers, such as a laser printer as long as the printers perform the multi-size dot printing. The invention also can be applied to other apparatuses, such as a facsimile apparatus or a copying machine besides the printer if the apparatus is equipped with an image processing apparatus corresponding to the printer driver 300.

The entire disclosure of Japanese Patent Application No: 2007-282962, filed Oct. 31, 2007 is expressly incorporated by reference herein.

What is claimed is:

1. An image processing apparatus for printing an image by recording a plural kinds of ink dots having different sizes on a print medium, comprising:
a print image placement acquiring unit which acquires placement of print images on the print medium, in which the print images are to be printed on the print medium; and
a print data generating unit which generates print data representing a recording state of the plural kinds of dots on the basis of ink amount data representing ink amount which is recorded on the print medium;
wherein the print data generating unit generates the print data so that the number of recordings for a specific kind of dots of the plural kinds of ink dots has different values according to placement of the print image with respect to the same ink amount data.

2. The image processing apparatus according to claim 1, wherein the specific kind of ink dots are ink dots having a size which is more approximate to a pixel size determined by print resolution rather than a size of ink dots other than the specific kind of ink dots out of the plural kinds of ink dots, and the print data generating unit generates the print data so that the number of recordings for the specific kind of ink dots in the case in which the print image is not placed at a center portion of the print medium is smaller than the number of recordings for the specific kind of ink dots in the case in which the print image is arranged on the center portion of the print medium.

3. The image processing apparatus according to claim 1, wherein the print data generating unit includes:
a recording rate data generating unit which generates recording rate data on the basis of the ink amount data; and
a data converting unit which converts the recording rate data to the print data,
wherein the recording rate generating unit sets a maximum recording rate for the specific kind of ink dots differently according to the placement of the print images.

4. The image processing apparatus according to claim 3, wherein the recording rate data generating unit includes:
a first recording rate table which shows a relationship between the ink amount and a recording rate of each of the plural kinds of ink dots;
a second recording rate table, of which a maximum recording rate of the specific kind of ink dots is different from a maximum recording rate of the specific kind of ink dots of the first recording rate table; and
a recording rate table selecting unit which selects either the first recording rate table or the second recording rate table as a recording rate table to be used to generate the recording rate data on the basis of the placement of the print image.

5. An image processing method for printing an image by recording a plural kinds of ink dots having different sizes on a print medium, comprising:
(a) acquiring placement of print images on the print medium, in which the print images are to be printed on the print medium; and
(b) generating print data representing recording states of the plural kinds of ink dots on the basis of ink amount data representing ink amount to be recorded on the print medium,
wherein the (b) generating print data generates the print data so that the number of recordings for the specific kind of ink dots of the plural kinds of ink dots has different values according to placement of the print images with respect to the same ink amount data.

6. A computer program to be executed by a computer for carrying out image processing for printing an image by recording a plural kinds of ink dots having different sizes on a print medium, the program causing a computer to execute functions of:
(a) acquiring placement of print images on the print medium, in which the print image are to be printed on the print medium; and
(b) generating print data representing recording states of the plural kinds of ink dots on the basis of ink amount data representing ink amount to be recorded on the print medium,
wherein the function (b) is for generating the print data with respect to the same ink amount data so that the number of recordings for a specific kind of ink dots of the plural kinds of ink dots has different values according to placement of the print image.
